(19) United States
(12) Patent Application Publication
(10) Pub. No.: US 2019/0305651 A1
(43) Pub. Date: Oct. 3, 2019

(54) MOTOR

(71) Applicant: NIDEC SERVO CORPORATION, Kiryu-shi (JP)

(72) Inventors: Runxiang MAO, Kiryu-shi (JP); Makoto YAJIMA, Kiryu-shi (JP)

(21) Appl. No.: 16/278,753

(22) Filed: Feb. 19, 2019

(30) Foreign Application Priority Data
Mar. 30, 2018 (JP) 2018-067964

(51) Int. Cl. H02K 11/40; H02K 5/10; H02K 5/22; H02K 21/14

(52) U.S. Cl. CPC H02K 11/40; H02K 5/10; H02K 2211/03; H02K 21/14; H02K 2207/03; H02K 5/225

(57) ABSTRACT

A motor includes a rotor including a shaft extending along a central axis, a stator radially facing the rotor, a circuit board electrically connected to a coil of the stator, and a motor case accommodating the stator and the circuit board. The motor case includes a first case portion with a bottomed tubular shape and a second case portion with a bottomed tubular shape. The first case portion and the second case portion are fixed by flange portions butted against each other in an axial direction. A grounding wire includes a first end connected to the circuit board and a second end attached to the flange portion.

### CROSS REFERENCE TO RELATED APPLICATIONS

This application claims the benefit of priority to Japanese Patent Application No. 2018-067964 filed on Mar. 30, 2018. The entire contents of this application are hereby incorporated herein by reference.

### BACKGROUND OF THE INVENTION

### 1. Field of the Invention

The present disclosure relates to a motor.

### 2. Description of the Related Art

Conventionally, as a direct current (DC) motor used for a consumer ventilator, a configuration, in which a stator, a rotor, and a circuit board on which an electronic component constituting a drive circuit is mounted and which is connected to a coil of the stator are included in the inside of a metallic tubular frame and a metallic motor cover that blocks an opening of the tubular frame, has been described. Further, there is also a related art in which the potential of a through hole of a circuit board is set to the ground (GND) potential.

In the motor as described above, in order to set the potential of the through hole of the circuit board to the GND potential, one end of a grounding wire is connected to the through hole (ground terminal) of the circuit board. The grounding wire is led out to the outside of the tubular frame and the motor cover. The other end of the grounding wire is connected to the tubular frame, the motor cover, or an external ground electrode.

However, in the case where the grounding wire is led out to the outside of the tubular frame and the motor cover, when current flows in the grounding wire, noise may be radiated from the grounding wire itself to the surroundings. Furthermore, when a power supply wire for supplying a current to the coil of the stator is connected to a power supply side connection terminal such as an outlet, the noise radiated from the grounding wire may propagate to other electronic devices via a power supply wire and a power supply connection terminal.

### SUMMARY OF THE INVENTION

An example embodiment of the present disclosure includes a rotor including a shaft extending along a central axis, a stator radially facing the rotor, a circuit board electrically connected to a coil of the stator, and a motor case to accommodate the rotor, the stator, and the circuit board. The motor case includes a first case portion with a bottomed tubular shape and a second case portion with a bottomed tubular shape. The first case portion and the second case portion are fixed by flange portions of the case portions butted against each other in an axial direction. A grounding wire includes a first end connected to the circuit board and a second end attached to the flange portion.

According to one aspect of the present disclosure, there is provided a motor capable of reducing or preventing noise generated during operation of a motor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view showing a motor according to an example embodiment of the present disclosure.

FIG. 2 is a perspective view showing a first case portion defining a motor case of a motor according to an example embodiment of the present disclosure.

FIG. 3 is a perspective view showing a second case portion defining a motor case according to an example embodiment of the present disclosure.

FIG. 4 is a view of a motor according to an example embodiment of the present disclosure as viewed from the second case portion side.

FIG. 5 is a view showing a main portion of a motor according to an example embodiment of the present disclosure, and is a sectional view taken along the line II-II of FIG. 4.

FIG. 6 is a sectional view showing a motor according to a variation of an example embodiment of the present disclosure.

### DETAILED DESCRIPTION OF THE PREFERRED EMBODIMENTS

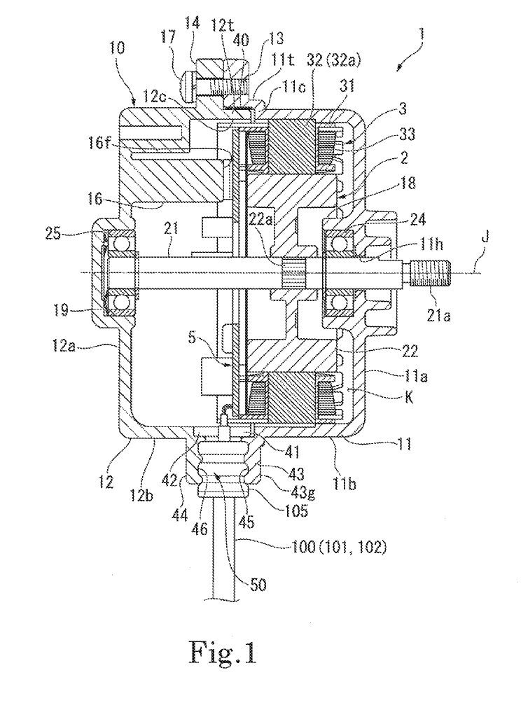

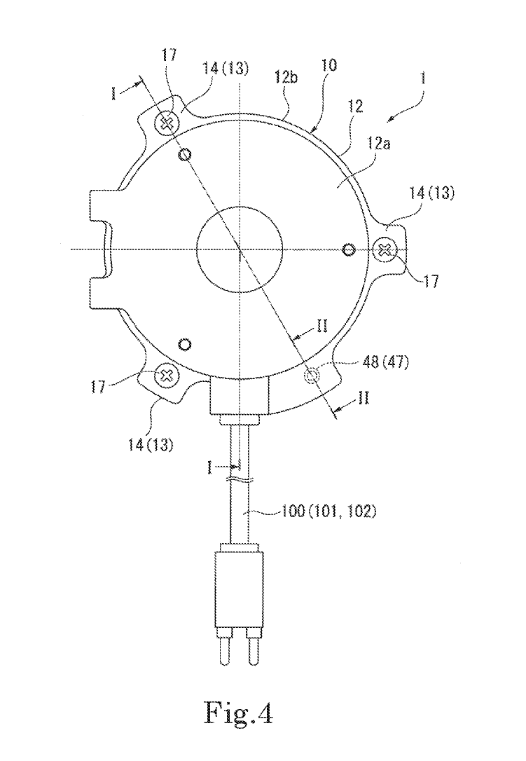

FIG. 1 is a sectional view showing a motor according to an example embodiment of the present disclosure. FIG. 1 is a sectional view taken along the line I-I of FIG. 4 to be described later.

The motor 1 of the present embodiment shown in FIG. 1 is for driving a fan of a ventilating fan, for example. The motor 1 mainly includes a rotor 2, a stator 3, a circuit board 5, and a motor case 10.

The rotor 2 includes a shaft 21 extending along a central axis J, a rotor core 22, and a permanent magnet (not shown). The shaft 21 extends in an axial direction along the central axis J. The shaft 21 is rotatably supported around the central axis J by bearings 24, 25 provided in the motor case 10. The rotor core 22 is provided radially outside the shaft 21. The rotor core 22 is fitted to a knurled portion 22a formed in an axial middle portion along the central axis J in the shaft 21 and rotates together with the shaft 21 around the central axis J. The permanent magnet (not shown) is provided on an outer peripheral surface of the rotor core 22. A plurality of permanent magnets (not shown) are provided in a circumferential direction around the central axis J.

The stator 3 is located radially outward of the rotor 2 and faces the permanent magnet (not shown) of the rotor 2 in a radial direction. The stator 3 mainly includes a stator core 31, a teeth portion 32, and a coil 33.

The stator core 31 is provided on an inner peripheral surface of the motor case 10. The stator core 31 is formed in a cylindrical shape as a whole by laminating a plurality of annular steel plates in the axial direction. The teeth portion 32 is provided radially inward of the stator core 31. The teeth portion 32 has a plurality of teeth 32a provided at equal intervals in a circumferential direction. Each of the teeth 32a extends radially inward. The coil 33 is wound around the teeth 32a.

The circuit board 5 supplies a current to the coil 33 of the stator 3. The circuit board 5 is in the form of a plate and is arranged in a plane orthogonal to the central axis J. The circuit board 5 is provided on one side (the left side in FIG. 1) in the axial direction along the central axis J with respect to the rotor 2 and the stator 3.

The motor case 10 accommodates the rotor 2, the stator 3, and the circuit board 5. The motor case 10 includes a first case portion 11 and a second case portion 12. Each of the first case portion 11 and the second case portion 12 is made by die casting in which a conductive metal material, such as an iron-based alloy, is formed into a predetermined shape by casting.

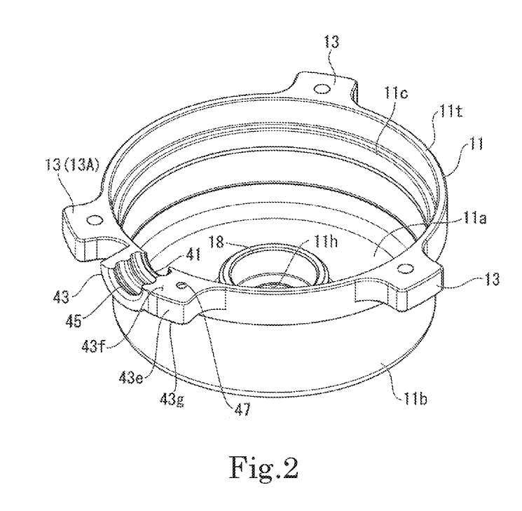

FIG. 2 is a perspective view showing the first case portion constituting the motor case of the motor of the present embodiment.

The first case portion 11 is provided on the other side (the right side in FIG. 1) in the central axis J direction. As shown in FIGS. 1 and 2, the first case portion 11 has a bottomed tubular shape, and includes a first bottom plate portion 11a, a first peripheral wall portion 11b, and a first connection flange portion (flange portion) 13 in an integrated manner.

The first bottom plate portion 11a is in the shape of a disk positioned in a plane orthogonal to the central axis J. In the center of the first bottom plate portion 11a, a bearing holding portion 18 for holding the bearing 24 is integrally provided. A shaft insertion hole 11h is formed in the center of the first bottom plate portion 11a. One end portion 21a of the shaft 21 protrudes outward from the motor case 10 in the direction of the central axis J through the shaft insertion hole 11h.

The first peripheral wall portion 11b has a cylindrical shape extending in an axial direction from an outer peripheral edge of the first bottom plate portion 11a. A first end portion 11c on the opposite side of the first bottom plate portion 11a in the first peripheral wall portion lib opens toward the other side in the axial direction.

The first peripheral wall portion lib has a first annular protruding portion lit that protrudes in a direction opposite to the first bottom plate portion 11a along the axial direction. The first annular protruding portion lit is cylindrical and has an inner diameter larger than an inner diameter of the first peripheral wall portion lib.

The first connection flange portion 13 extends radially outward from the first annular protruding portion lit provided at the first end portion 11c of the first peripheral wall portion lib. The first connection flange portion 13 is provided at a plurality of positions spaced apart in a circumferential direction. In the present embodiment, the first connection flange portions 13 are provided at three positions at equal intervals in the circumferential direction.

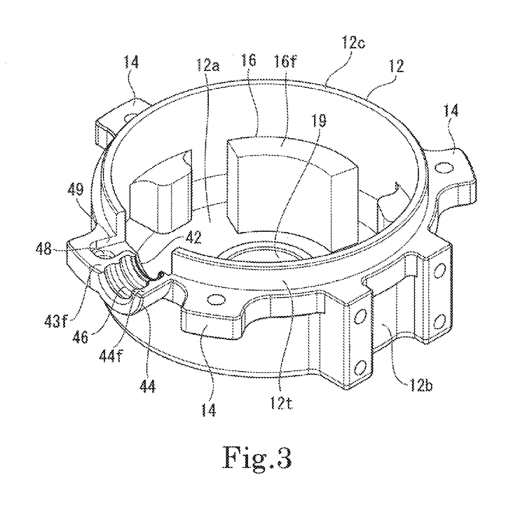

FIG. 3 is a perspective view showing the second case portion constituting the motor case of the present embodiment.

As shown in FIG. 1, the second case portion 12 is provided on one side in the central axis J direction. As shown in FIGS. 1 and 3, the second case portion 12 has a bottomed tubular shape, and includes a second bottom plate portion 12a, a second peripheral wall portion 12b, and a second connection flange portion (flange portion) 14 in an integrated manner.

The second bottom plate portion 12a is in the shape of a disk positioned in a plane orthogonal to the central axis J. In the center of the second bottom plate portion 12a, a bearing holding portion 19 for holding the bearing 25 is integrally provided.

The second peripheral wall portion 12b has a cylindrical shape extending in an axial direction from an outer peripheral edge of the second bottom plate portion 12a. A second end portion 12c on the opposite side of the second bottom plate portion 12a in the second peripheral wall portion 12b opens. The second peripheral wall portion 12b has a second annular protruding portion 12t that protrudes in a direction opposite to the second bottom plate portion 12a along the axial direction. The second annular protruding portion 12t is cylindrical and has an inner diameter equal to that of the second peripheral wall portion 12b. An outer diameter of the second annular protruding portion 12t is slightly smaller than the inner diameter of the first annular protruding portion lit.

The second connection flange portion 14 extends radially outward from the second end portion 12c of the second peripheral wall portion 12b. The second connection flange portion 14 is provided at a plurality of positions spaced apart in the circumferential direction. In the present embodiment, the second connection flange portions 14 are provided at three positions at equal intervals in the circumferential direction.

A heat sink 16 is integrally provided on the second bottom plate portion 12a of the second case portion 12. The heat sink 16 protrudes in a direction away from the second bottom plate portion 12a along the axial direction. A front end surface 16f of the heat sink 16 is brought into contact with a heat generating electric element mounted on the circuit board 5 to radiate the heat of the electric element.

As shown in FIG. 1, the first case portion 11 and the second case portion 12 are combined in a state where the first end portion 11c of the first peripheral wall portion 11b and the second end portion 12c of the second peripheral wall portion 12b are caused to face each other in the axial direction. The first case portion 11 and the second case portion 12 are coupled and fixed by butting the first connection flange portion 13 and the second connection flange portion 14 against each other in the axial direction and fastening them with a screw 17. Further, the first annular protruding portion lit and the second annular protruding portion 12t are fitted to each other between the first case portion 11 and the second case portion 12. The second annular protruding portion 12t of the second case portion 12 is inserted on an inner side of the first annular protruding portion lit of the first case portion 11.

A sealing material 40 is provided between an inner peripheral surface of the first annular protruding portion lit and an outer peripheral surface of the second annular protruding portion 12t. Prior to inserting the second annular protruding portion 12t on an inner side of the first annular protruding portion lit, the sealing material 40 is preferably applied to at least either one of the outer peripheral surface of the second annular protruding portion 12t and the inner peripheral surface of the first annular protruding portion lit.

The rotor 2, the stator 3, and the circuit board 5 are accommodated in space K formed by the first bottom plate portion 11a and the first peripheral wall portion lib of the first case portion 11. The circuit board 5 is disposed radially inward of the first annular protruding portion lit and the second annular protruding portion 12t in the first case portion 11.

FIG. 4 is a view of the motor according to the present embodiment as viewed from the second case portion side.

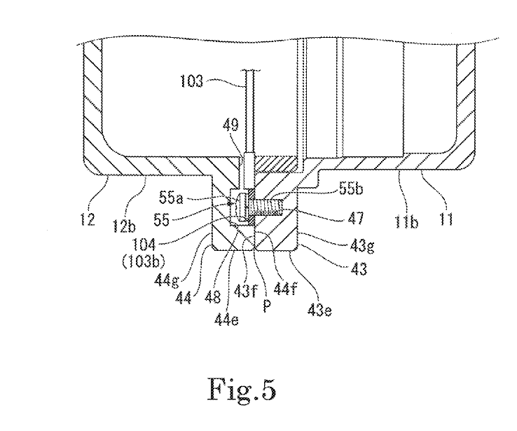

As shown in FIG. 1 and FIG. 4, a power supply wire 101 and a signal wire 102, and a grounding wire (see FIG. 5) 103 are connected to the circuit board 5 in the motor case 10.

The power supply wire 101 supplies a current to the circuit board 5. The signal wire 102 inputs and outputs a control signal and the like between the circuit board 5 and an external controller (not shown). The power supply wire 101 and the signal wire 102 are bundled into one wire 100, one end of which is connected to the circuit board 5, and the other end of which is led out to the outside of the motor case 10.

As shown in FIGS. 1 and 2, the first annular protruding portion lit provided on the first peripheral wall portion lib of the first case portion 11 has a notch portion 41 for radially inserting the wire 100 in part of the circumferential direction. Further, the first case portion 11 includes a first wire flange portion (flange portion, first flange portion) 43 extending radially outward from the first annular protruding portion lit. The first wire flange portion 43 is provided at the same position as the first connection flange portion 13 in the axial direction. The first wire flange portion 43 includes a radially outer portion of the notch portion 41 and is provided continuously over a fixed length in the circumferential direction.

On a surface 43f of the first wire flange portion 43 facing the other side in the axial direction, a guide groove 45 extending continuously radially outward from the notch portion 41 is formed.

FIG. 5 is a view showing a main part of the motor in the present embodiment, and is a sectional view taken along the line II-II of FIG. 4.

As shown in FIG. 2, a female screw hole 47 is formed in the first wire flange portion 43 at a position offset in the circumferential direction with respect to the guide groove 45. As shown in FIGS. 2 and 5, the female screw hole 47 extends from the surface 43f facing the other side in the axial direction in the first wire flange portion 43 toward a surface 43g facing one side in the axial direction, and does not penetrate the surface 43g. The female screw hole 47 is disposed more radially inner side than an outer circumferential end portion 43e on a radially outer side of the first wire flange portion 43 by a predetermined dimension. The female screw hole 47 is disposed on the opposite side to one of the first connection flange portions 13A across the guide groove 45.

As shown in FIGS. 1 and 3, a notch portion 42 for inserting the wire 100 in the radial direction is formed in part of the second peripheral wall portion 12b of the second case portion 12 in the circumferential direction. Further, the second case portion 12 includes a second wire flange portion (flange portion, second flange portion) 44 extending radially outward from the second peripheral wall portion 12b. The second wire flange portion 44 is provided at the same position as the second connection flange portion 14 in the axial direction. The second wire flange portion 44 includes a radially outer portion of the notch portion 42 and is provided continuously over a fixed length in the circumferential direction.

On the second wire flange portion 44, a guide groove 46 extending continuously radially outward from the notch portion 42 is formed on a surface 44f facing the other side in the axial direction.

As shown in FIGS. 3 and 5, a relief portion 48 is formed on the second wire flange portion 44 at a position offset in the circumferential direction with respect to the guide groove 46. The relief portion 48 is recessed from the surface 44f facing one side in the axial direction on the second wire flange portion 44 toward the surface 44g facing the other side in the axial direction. The relief portion 48 does not penetrate the surface 44g. The relief portion 48 is disposed more radially inner side than an outer circumferential end portion 44e that is radially outer side of the second wire flange portion 44 by a predetermined dimension.

On the second case portion 12, a notch groove 49 extending radially inward from the relief portion 48 is formed. The notch groove 49 is recessed from the surface 44f facing one side in the axial direction on the second wire flange portion 44 toward the surface 44g facing the other side in the axial direction. Furthermore, the notch groove 49 continues from the second wire flange portion 44 to a radially inner side of the second annular protruding portion 12t.

Note that the notch groove 49 may be formed in the first wire flange portion 43 of the first case portion 11 or may be formed on both the first wire flange portion 43 of the first case portion 11 and the second wire flange portion 44 of the second case portion 12.

As shown in FIGS. 1 and 5, in a state in which the first connection flange portion 13 of the first case portion 11 and the second connection flange portion 14 of the second case portion 12 are axially butted against each other, the first wire flange portion 43 and the second wire flange portion 44 are axially butted against each other. The surface 43f of the first wire flange portion 43 and the surface 44f of the second wire flange portion are brought into close contact with each other. A sealing material may be provided between the surface 43f of the first wire flange portion 43 and the surface 44f of the second wire flange portion 44.

As shown in FIG. 1, in a state where the first wire flange portion 43 and the second wire flange portion 44 are butted against each other, the notch portion 41 and the notch portion 42, the guide groove 45 and the guide groove 46 axially face each other to form a wire insertion hole 50. The wire 100 is drawn from the inside of the motor case 10 to the outside through the wire insertion hole 50. A tubular grommet 105 is mounted on the wire 100 inserted through the wire insertion hole 50. The grommet 105 is made of a rubber-based material or the like, and seals between the wire 100 and the guide grooves 45, 46.

Further, as shown in FIG. 5, the female screw hole 47 and the relief portion 48 axially face each other in a state where the first wire flange portion 43 and the second wire flange portion 44 are butted against each other. A portion P where the surface 43f of the first wire flange portion 43 and the surface 44f of the second wire flange portion 44 are butted against each other is provided radially outward with respect to the female screw hole 47 and the relief portion 48.

One end (not shown) of the grounding wire 103 is connected to the circuit board 5 (see FIG. 1), and the other end 103b is grounded to the motor case 10. On the other end 103b of the grounding wire 103, a connection terminal 104 having a screw insertion portion is provided. The grounding wire 103 passes through between the surface 43f of the first wire flange portion 43 of the first case portion 11 and the notch groove 49 formed on the second case portion 12 and extends between the first wire flange portion 43 and the second wire flange portion 44. The connection terminal 104 provided at the other end 103b of the grounding wire 103 is axially butted against the surface 43f of the first wire flange portion 43 of the first case portion 11 and is fixed to the first wire flange portion 43 by a screw member 55.

The screw member 55 has a screw portion 55b screwed into the female screw hole 47 formed in the first wire flange portion 43. A head portion 55a of the screw member 55 projecting from the surface 43f of the first wire flange portion 43 is accommodated in the relief portion 48 formed in the second wire flange portion 44 of the second case portion 12. Here, an inner side of the relief portion 48 may be filled with a sealing material to enhance the sealing property.

The connection terminal 104 provided at the other end 103b of the grounding wire 103 attached to the first wire flange portion 43 in this way is disposed on a radially inner side of the portion P where the first wire flange portion 43 and the second wire flange portion 44 are butted against each other.

According to the present embodiment, the other end 103b of the grounding wire 103 having one end (not shown) connected to the circuit board 5 is attached to the first wire flange portion 43. In this manner, the grounding wire 103 extending from the circuit board 5 can be connected to the first wire flange portion 43 in the motor case 10 without being exposed to the outside of the motor case 10. Further, since the grounding wire 103 can have a minimum length connecting the circuit board 5 and the first wire flange portion 43, generation of noise can be suppressed by reducing the length of the grounding wire 103. In this way, compared with a configuration in which the grounding wire 103 is exposed to the outside of the motor case 10, it is possible to suppress noise generated when the motor is operated. Therefore, even when the power supply wire 101 is connected to the power supply side connection terminal such as an outlet, it is possible to suppress the noise radiated from the grounding wire 103 from propagating to other electronic devices via the power supply wire 101.

According to the present embodiment, in the first case portion 11, the grounding wire 103 is disposed radially inward of the portion P where the first wire flange portion 43 and the second wire flange portion 44 are butted against each other. As a result, the grounding wire 103 is accommodated on an inner side of the portion P where the first wire flange portion 43 and the second wire flange portion 44 are butted against each other without being sandwiched between the first wire flange portion 43 and the second wire flange portion 44. Therefore, since the adhesion between the first wire flange portion 43 and the second wire flange portion 44 is improved, the waterproofness inside the motor case 10 is enhanced.

According to the present embodiment, the grounding wire 103 is fixed to the first wire flange portion 43 via the screw member 55. In this manner, the grounding wire 103 can be reliably fixed to the first wire flange portion 43.

According to the present embodiment, the second wire flange portion 44 has the relief portion 48 for accommodating the head portion 55a of the screw member 55. In this manner, the interference between the screw member 55 and the second wire flange portion 44 can be prevented.

According to the present embodiment, the rotor 2, the stator 3, and the circuit board 5 are accommodated in the space K of the first case portion 11, and the other end 103b of the grounding wire 103 is attached to the first wire flange portion 43. In this way, the circuit board 5 to which one end (not shown) of the grounding wire 103 is connected and the first wire flange portion 43 to which the other end 103b is connected are provided on the first case portion 11 side. In this manner, when the motor 1 is assembled, the second case portion 12 is preferably attached to the first case portion 11 after the circuit board 5 and the grounding wire 103 are assembled on the first case portion 11 side. As described above, since the grounding wire 103 can be attached in a state in which the second wire flange portion 44 is removed, workability is improved.

According to the present embodiment, the first peripheral wall portion lib includes the first annular protruding portion lit that axially protrudes, and the second peripheral wall portion 12b includes the second annular protruding portion 12t that axially extends and is fitted to the first annular protruding portion lit. In this manner, when the first case portion 11 and the second case portion 12 are combined, alignment of the first case portion 11 and the second case portion 12 can be easily performed by fitting the first annular protruding portion lit and the second annular protruding portion 12t to each other. Further, as the first annular protruding portion lit and the second annular protruding portion 12t are fitted to each other, the airtightness inside the motor case 10 is improved, and the waterproofness of the motor 1 is enhanced.

According to the present embodiment, the first annular protruding portion lit and the second annular protruding portion 12t have the notch portions 41, 42 for drawing out the grounding wire 103 to the first wire flange portion 43. In this manner, it is possible to prevent the grounding wire 103 from being caught between the first annular protruding portion lit and the second annular protruding portion 12t.

According to the present embodiment, the sealing material 40 provided between the first annular protruding portion lit and the second annular protruding portion 12t is included. Since a gap between the first case portion 11 and the second case portion 12 is sealed by the sealing material 40, the waterproofness of the motor 1 can be improved.

Further, since the female screw hole 47 to which the screw member 55 is fastened does not penetrate to the surface 43g side of the first wire flange portion 43, moisture or the like can be prevented from entering from the outside through the female screw hole 47. Therefore, also in this respect, the waterproofness of the motor 1 is enhanced.

In the above embodiment, the first case portion 11 and the second case portion 12 of the motor case 10 are made by die casting, but the present invention is not limited to the above.

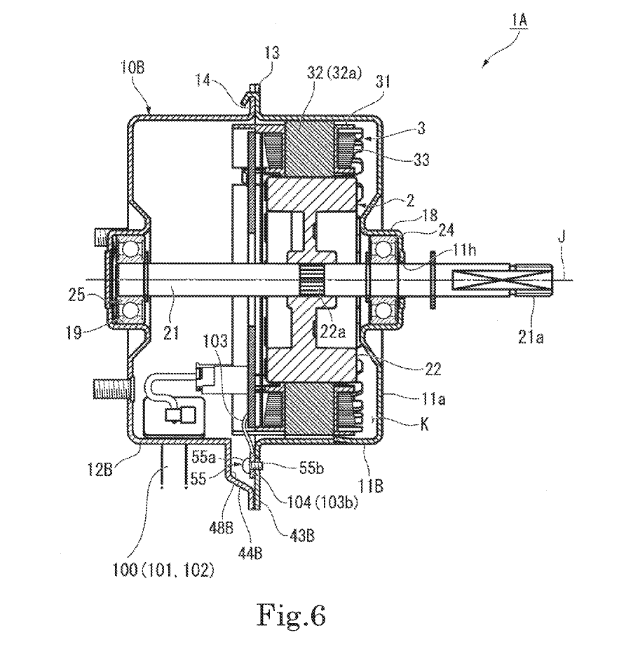

For example, as shown in FIG. 6, a first case portion 11B and a second case portion 12B of a motor case 10B may be formed by applying press working or the like to a conductive metal plate. In this case, the connection terminal 104 provided at the other end 103b of the grounding wire 103 is fixed to a first wire flange portion (a flange portion, a first flange portion) 43B, which is provided on the first case portion 11B in a manner extending radially outward, by the screw member 55. A second wire flange portion (flange portion, second flange portion) 44B is provided in the second case portion 12B at a position facing the first wire flange portion 43B. A relief portion 48B for accommodating the head portion 55a of the screw member 55 is formed on the second wire flange portion 44B.

While an embodiment of the present disclosure and a variation are described above, it will be understood that features, a combination of the features, and so on according to the embodiment and the variation are one example, and that an addition, elimination, and substitution of a feature(s), and other modifications can be made without departing from the scope and spirit of the present disclosure. Further, the present disclosure is not limited by the embodiment.

For example, the application of the motor 1 described in the above embodiment and variation is not particularly limited.

Further, in the above embodiment, the first wire flange portion 43 and the second wire flange portion 44 are provided separately from the first connection flange portion 13 and the second connection flange portion 14. However, the present invention is not limited to the above. The first wire flange portion 43 and the first connection flange portion 13, the second wire flange portion 44 and the second connection flange portion 14 may be integrally formed in a continuous manner in the circumferential direction.

Further, in the above embodiment, the grounding wire 103 is fixed to the first wire flange portion 43. However, it may be fixed to the second wire flange portion 44 of the second case portion 12.

Further, in the above embodiment, the female screw hole 47 does not penetrate to the surface 43g side of the first wire flange portion 43. However, the present invention is not limited to the above. The female screw hole 47 may axially penetrate the first wire flange portion 43. In this case, it is preferable to provide a sealing material between the female screw hole 47 and the screw portion 55b of the screw member 55 in order to secure waterproofness.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a rotor including a shaft extending along a central axis;
a stator radially facing the rotor;
a circuit board electrically connected to a coil of the stator; and
a motor case to accommodate the rotor, the stator, and the circuit board; wherein
the motor case includes a first case portion with a bottomed tubular shape and a second case portion with a bottomed tubular shape;
the first case portion and the second case portion are fixed by flange portions of the first and second case portions butted against each other in an axial direction; and
a grounding wire includes a first end connected to the circuit board and a second end attached to at least one of the flange portions.

2. The motor according to claim 1, wherein
the first case portion further includes a tubular first peripheral wall portion extending from an outer peripheral edge of a first bottom plate portion in an axial direction, and a first flange portion extending radially outward from a first end portion on an opposite side to the first bottom plate portion in the axial direction;
the second case portion further includes a tubular second peripheral wall portion extending from an outer peripheral edge of a second bottom plate portion and disposed in a manner facing the first peripheral wall portion, and a second flange portion extending radially outward from a second end portion on an opposite side to the second bottom plate portion in the axial direction; and
the grounding wire is disposed radially inward of an area where the first flange portion and the second flange portion are butted against each other.

3. The motor according to claim 2, wherein the grounding wire is fixed to one of the first flange portion and the second flange portion by a screw.

4. The motor according to claim 3, wherein another one of the first flange portion and the second flange portion includes a relief portion to accommodate a head of the screw.

5. The motor according to claim 2, wherein
the rotor, the stator, and the circuit board are accommodated in a space defined by the first bottom plate portion and the first peripheral wall portion of the first case portion; and
the second end of the grounding wire is attached to the first flange portion.

6. The motor according to claim 2, wherein
the first peripheral wall portion includes a first annular protruding portion that protrudes in the axial direction; and
the second peripheral wall portion includes a second annular protruding portion extending in the axial direction and fitted to the first annular protruding portion.

7. The motor according to claim 6, wherein at least one of the first annular protruding portion and the second annular protruding portion includes a notch portion to enable drawing out of the grounding wire to the flange portion.

8. The motor according to claim 6, further comprising a seal at least between the first annular protruding portion and the second annular protruding portion.
